(19) United States
(12) Patent Application Publication
(10) Pub. No.: US 2007/0100036 A1
(43) Pub. Date: May 3, 2007

(54) Optical film and method of manufacturing the same

(75) Inventors: Kuang-Rong Lee, Taoyuan (TW); Tan-Ching Wang, Taoyuan (TW); Min-Wei Cheng, Taoyuan (TW); Yu-Hwey Chuang, Taoyuan (TW)

Correspondence Address: NIKOLAI & MERSEREAU, P.A., 900 SECOND AVENUE SOUTH, SUITE 820, MINNEAPOLIS, MN, 55402, US

(73) Assignee: OPTIMAX TECHNOLOGY CORPORATION, Taoyuan (TW)

(21) Appl. No.: 11/583,516

(22) Filed: Oct. 18, 2006

(30) Foreign Application Priority Data
Jun. 20, 2006 (TW) 095122016
Oct. 31, 2005 (CN) 200510118586.2

(51) Int. Cl. C08J 3/09

(52) U.S. Cl. 524/113; 524/556; 524/356; 524/366

(57) ABSTRACT

The present invention discloses an optical film and method of manufacturing the same. The selected PMMA is well mixed with a solvent to form a wet film by employing a solvent molding technology, and then the wet film is heated to form a dry film. The optical film comprises a material at least selected from a group consisting of PMMA, PMMA with a first functional group replaced by a second functional group and PMMA of intermixing a mixture; and a solvent well mixed with the material selected from the group consisting of PMMA, PMMA with a first functional group replaced by a second functional group and PMMA of intermixing a mixture at a predetermine proportion to form a mixing solution under various conditions, thereby the optical film is formed from the mixing solution by way of a dry treatment.

### BACKGROUND OF THE INVENTION

1. Field of the Invention

The present invention relates to an optical film and a method for manufacturing the same by mixing optical synthetic polymer, and more particularly to a PMMA (Polymethyl Methacrylate) optical film and a method for fabricting the same by employing a solvent molding technology.

2. Description of the Prior Art

A conventional substrate be utilized as an optical film is generally adopted to triacetate (TAC), polycarbonate (PC) or COP. Typically, TAC film may further be acted as protective film and supporting film of optical film. Therefore, general TAC film must not only meet the criterions of optical property but also provide with some property such as appropriately strength, heat-resistant and wet-resistant to meet the criterions for optical film and providing protection effect. (Refer to following patents including JP4342202, TW499573, JP2000-324055, JP2001-235625, JP2003-195048, EP 1-285742 and EP 1-331245.) Moreover, U.S. Pat. No. 6,652,926B1 disclose that silica particles with 0.04˜0.3 percentage by weight are added into TAC, thereby improving toughness and reducing thickness of TAC film.

However, regarding to the manufacture of substrate or protective film, U.S. 2004/0086721A1 discloses that the substrate or protective film is produced by employing melt intermixing method to mix together with PVDF with 20˜40% by weight, PMMA with 40˜60% by weight and acrylic elastomer with 5˜18% by weight. EP 1154005A1 discloses that the roughness of PET film is in a range of from 20 to 600 nm by employing PET film mixed with fine particles of less than 5 micron. Moreover, JP. 7-56017 discloses that film having thickness of 80 micron formed by mixing polycarbonate (PC) in a composition of 80% by weight with PMMA (Kuraray C-16) in a composition of 20% by weight and film having thickness of 500 micron formed by mixing PMMA (MMA97%, BA3%) in a composition of 75% by weight with PET in a composition of 25% by weight.

There are some drawbacks of prior art technology, in which includes hydroscopicity property of TAC film is so large that optical property of the optical film may be effected seriously due to deformation of film or induced stress under high temperature and high humidity conditions, even causing the optical film does not work any more. Moreover, high b value of TAC film is easy to cause vision obstruction according to appearance. Besides, there are some problems for COP film (such as Zeonor [symbol] Arton) including excessive small hydroscopicity property, poor adhesion and friability. EP 1154005A1 discloses that fine particles may reduce surface roughness but result in lower glass transition temperature (75° C.) of PET, therefor it is difficult to meet the criterions for heat-resistant of optical film. JP 7-56017 discloses that friability property of the mixing material of PMMA/PC and the thickness of the mixing material of PMMA/PEA reaches to 500 micron such that optical film formed with the above mixing material is insufficient for application relative to the present optical film. In view of the above-mentioned drawbacks, and avoid generating unstable material owing to melting, mixing or thermoplastic process to improve heat-resistant, wet-resistant and mechanical property of optical film. Accordingly, the present invention provides an optical film and method of manufacturing the same for resolving the above-mentioned problems, especially for the stability of optical film.

### SUMMARY OF THE INVENTION

The objective of the present invention is to disclose a PMMA optical film and the manufacturing method of the PMMA optical film by employing a solvent molding technology. The PMMA may be dissolved in non-toxicity solvent such as methylbenzene to avoid using dichloromethane in a large amount during the process of manufacturing triacetate (TAC) from resulting in injury to human body and pollution of environment.

Another objective of the present invention is to provide an optical film with moderate hydroscopicity property to solve effectively the variation of the optical film.

The objective of the present invention is also provide to an optical film with good heat-resistant, moderately mechanical property, low coefficient of optical elasticity, excellent optical properties such as low nebulization, low yellowness index, high Abbe number, high transmittance (more than 90 percent) between a wavelength of 400 nm and 700 nm within the range of visible light and provided with uniform surface of film, for example, uniform thickness and roughness, to avoid causing unstable material due to melting, mixing or thermoplastic processing.

The present invention discloses an optical film which comprises a material, at least selected from a group consisting of PMMA, PMMA with a first functional group replaced by a second functional group and PMMA of intermixing a mixture; and a solvent, well mixed with the material selected from the group consisting of PMMA, PMMA with a first functional group replaced by a second functional group and PMMA of intermixing a mixture at a predetermine proportion to form a mixing solution under various conditions, thereby the optical film is formed from the mixing solution by way of a dry treatment. The composition of resulting mixing solution comprises 20˜40 percentage by weight of PMMA, thereby forming the optical film after performing a dry treatment.

The first functional group is methyl, and the second functional group is selected from the group consisting of ethyl, propyl, isopropyl, butyl, isobutyl, tert-butyl, hexyl, isohexyl and cyclohexyl. The mixture comprises polymer, small molecular, plasticizer, UV absorbent, anti-degradation agent or nona-meter particles mixture. The solvent comprises methylbenzene, acetone, methyl acetate, aromatic, cycloalkanes, ethers, esters or ketones. The comprises methylbenzene or o-, m-, p-xylene. The cycloalkanes comprises cyclohexane. The ethers comprises diethyl ether or tetrahydrofuran (THF). The esters comprises methyl acetate or ethyl acetate. The ketones comprises acetone, methylethylketone (MEK) or 1-methylpyrrolidone (NMP). The thickness of the optical film is substantially 20˜200 micron. The optical film may be an optical film substrate or optical protective film applied to LCD, LED, OLED or PLED.

The present invention discloses a method for manufacturing an optical film. The method comprises mixing at least one material selected from the group consisting of PMMA, PMMA with a first functional group replaced by a second functional group and PMMA of intermixing a mixture with a solvent to form a uniform mixing solution; dispersing the mixing solution onto a substrate; and, performing a dry treatment to form an optical film with uniform surface.

The mixing solution is dispersed onto the substrate by employing a solvent molding technology. The solvent molding technology comprises any one of scraper coating, winding stick coating, clockwise-or-counterclockwise roller coating, air curtain coating, wheeled coating, engraving tube coating, immersing coating, spin coating, slitting coating, squeezing coating, screening coating, extruded molding coating and injection molding coating. The synthetic polymer comprises any one of polyethyleneterephthalate (PET), polyethylenenaphthalate (PEN), polyethersulfone (PES), polyimide (PI), polyarylate (PAR), polycarbonate (PC) and natural fiber, said natural fiber is formed of a material selecting from the group consisting of cellulose acid (CA), cellulose diacetate (DAC) and cellulose triacetate (TAC). The thickness of the mixing solution dispersing onto the substrate is substantially 150˜1200 micron. The dry treatment is employed by using UV light irradiating the mixing solution dispersed onto the substrate.

The method of the present invention further comprises coating discotic liquid crystals on the optical film to perform alignment process by employing roller friction or UV exposing, thereby forming a retardation optical film with a phase difference

Moreover, the optical film of the present invention further comprising adding particles made of rubber elastic material into the material selected from the group consisting of PMMA, PMMA with a first functional group replaced by a second functional group and PMMA of intermixing a mixture. The rubber elastic material comprises any one of butyl acrylate, PMMA, styrene and the combination thereof. The diameter of particles made of the rubber elastic material is less than 10 micron or even nano-meter scale to improve mechanical property of the optical film.

### BRIEF DESCRIPTION OF THE DRAWINGS

The above objects, and other features and advantages of the present invention will become more apparent after reading the following detailed description when taken in conjunction with the drawings, in which:

FIG. 1 is a flow chart of manufacturing an optical film according to the present invention.

FIG. 2 is a testing table of PMMA film of the present invention.

FIG. 3 is a testing table showing resulting character of PMMA film with silica added into according to the present invention.

### DESCRIPTION OF THE PREFERRED EMBODIMENT

Some embodiments of this invention will now be described in greater detail. Nevertheless, it should be recognized that the present invention can be practiced in a wide range of other embodiments besides those explicitly described, and the scope of the present invention is expressly not limited expect as specified in the accompanying claims.

An optical film disclosed by the present invention comprises a material, at least selected from a group consisting of PMMA, PMMA with a first functional group replaced by a second functional group and PMMA of intermixing a mixture; and a solvent, well mixed with the material selected from the group consisting of PMMA, PMMA with a first functional group replaced by a second functional group and PMMA of intermixing a mixture at a predetermine proportion to form a mixing solution under various conditions, thereby the optical film is formed from the mixing solution by way of a dry treatment.

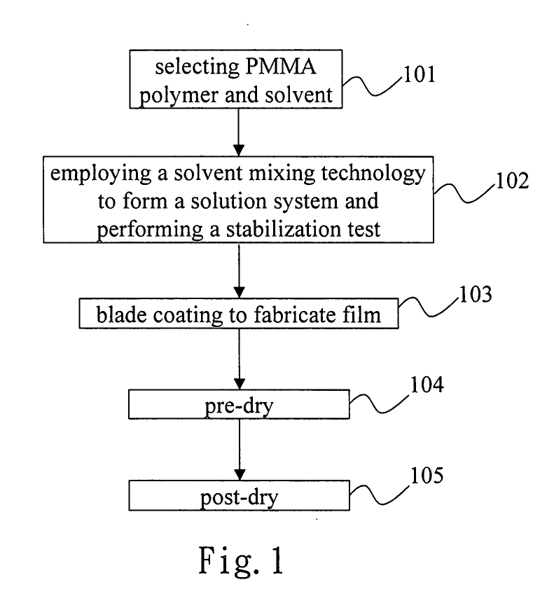

Referring to FIG. 1, it is a flow chart of manufacturing an optical film according to the present invention. In view of the manufacturing of an optical film of the present invention, firstly, in step 101 selecting one or more PMMA and/or modified PMMA by physical/chemical approach mixing with a predetermined proportion to fit various conditions and dissolve into a solvent. In one embodiment, the chemical approach comprises modified PMMA with a first functional group replaced by a second functional group. In one embodiment, the first functional group is methyl, and the second functional group comprises ethyl, propyl, isopropyl, butyl, isobutyl, tert-butyl, hexyl, isohexyl or cyclohexyl. For example, the physical approach comprises modified PMMA of intermixing a mixture. The mixture comprises at least one polymer, small molecular, plasticizer, UV absorbent, anti-degradation agent or nona-meter particles mixture. In one embodiment, the above-mentioned solvent comprises methylbenzene, acetone, methyl acetate, aromatic, cycloalkanes, ethers, esters or ketones. The aromatic comprises methylbenzene or o-, m-, p-xylene. The cycloalkanes comprise cyclohexane. The ethers comprise diethyl ether or tetrahydrofuran (THF). The esters comprise methyl acetate or ethyl acetate. The ketones comprise acetone, methylethylketone (MEK) or 1-methylpyrrolidone (NMP). Moreover, the above solvent is only examples but not limited to the present invention.

The diameter of the fine particles may be no more than 100 nm, it is preferred less than 80 nm, more preferably less than 50 nm.

In one embodiment, the present invention provides a solvent molding technology for manufacturing PMMA optical film, the following four conditions including different recipe, composition and solvent have been taken into account:

1. Degussa 8N 100 part, Toluene 200 part;

2. Degussa 8N 97.5 part, Kuraray GR00100 2.5 part, Acetone 200 part;

3. Degussa 8N 80 part, Degussa zk5BR 2.5 part, Methyl acetate 200 part;

4. Degussa 8N 50 part, Kuraray GR04940 2.5 part, Toluene 200 part.

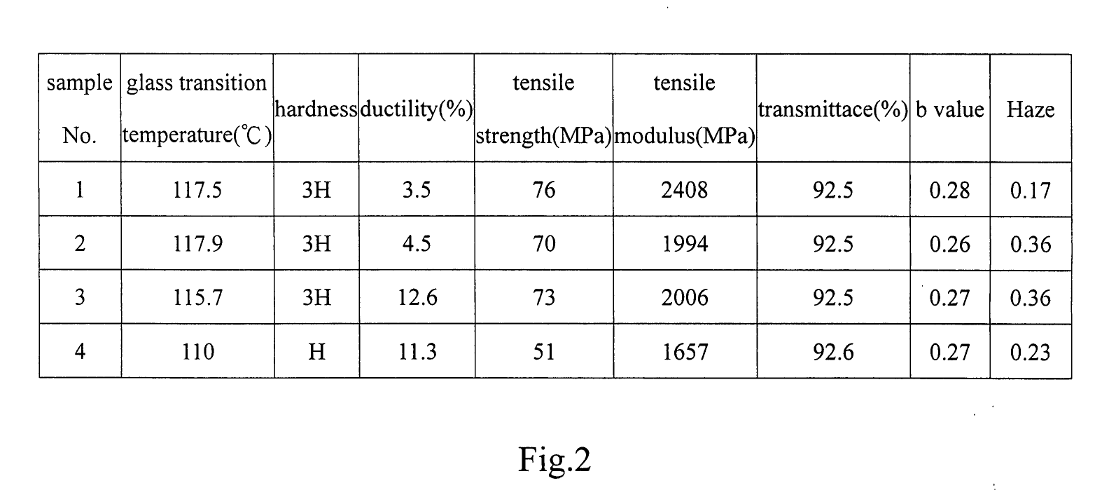

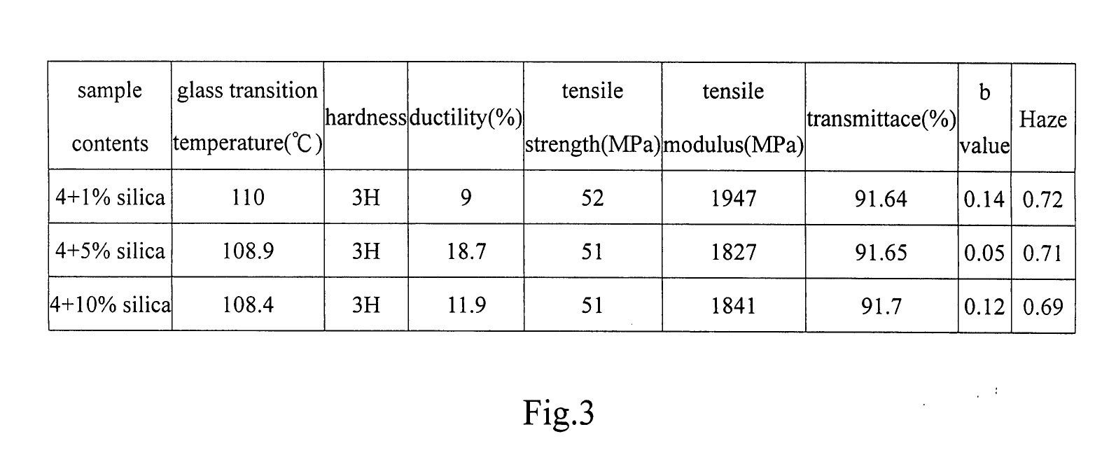

Subsequently, the step 102 is performed. The selected PMA polymer and solvent are mixed with each other to form a solution system by employing a solvent mixing technology, and then performing a stabilization test. Please refer to FIG. 2 showing the result of the test. Moreover, FIG. 3 is a schematic view showing various physical/chemical property of PMA added with a small amount of silica. The amount of silica may be 0.5˜15 percentage by weight.

The above-mentioned Kuraray GR series may be selected from GR04940, GR04970, GR00100, GR01240, GR01270, GR1000H24, GR1000H42 and GR1000H60, or selected from any one of Degussa zk3BR, zk4BR, zk5BR, zk6BR, zk4HC, zk5HC, k6HC, zk5HT, zk6HT, zkHF, zk6HF, zk20, zk30, zk40 and zk50. It is preferred that the composition of PMMA is 20˜40 percentage by weight in the solution. Next, the step 103 is performed. The mixing solution is uniformly dispersed onto a substrate by employing a solvent molding technology. For example but not limited to, the substrate comprises glass substrate, plastic substrate, steel plate, steel belt and synthetic polymer with good surface uniformity. The synthetic polymer comprises polyethyleneterephthalate (PET), polyethylenenaphthalate (PEN), polyethersulfone (PES), polyimide (PI), polyarylate (PAR), polycarbonate (PC) and natural fiber, said natural fiber comprises a material selected from the group consisting of cellulose acid (CA), cellulose diacetate (DAC) and cellulose triacetate (TAC). In the step 103, the mixing solution is spread onto the glass substrate by a blade in the present invention. For example but not limited to, gap of the blade comprises 550, 650 or 400 micron. Furthermore, for example but not limited to, the solvent molding method comprises winding stick coating, clockwise-or-counterclockwise roller coating, air curtain coating, wheeled coating, engraving tube coating, immersing coating, spin coating, slitting coating, squeezing coating, screening coating to produce an uniform optical film.

The above-mentioned solvent molding method may comprise extruded molding coating and injection molding coating through mirror molding to fabricate optical film.

After the above-mentioned coating, the optical film with a solvent is formed as a wet film. The thickness of the wet film depends on deferent demands. The thickness of the wet film is preferably 150˜1200 micron. Subsequently, an oven is employed to raise the temperature (such as UV light irradiating) by way of staged or continuous method, thereby enabling the wet film generated from the aforementioned method to dry. It is preferred that the residue of solvent is no more than 1 percent by dry treatment, thus to form an optical film with good optical property and uniform surface. Generally, the optical film relative to wet film is called the dry film. The thickness of the dry film is determined by the ratio of solvent, heating time and temperature. The dispersion of solution may be improved by employing a surface chemical treatment of the dry film. Meanwhile, it purpose to enhance heat-resistant ability and uniformity of the dry film.

The aforementioned various recipe, composition and solvent of optical film with PMMA are heated to 90° C. and violently stirring for about one hour at such temperature. After particles are completely dissolved, than to remove the heat resource from the mixing solution and continuously stir the mixing solution until cooling to room temperature. Next, the mixing solution is filtered by a sieve having 35 micron and waiting for a period of time. The mixing solution is poured upon the glass substrate and using blade having a gap of 550 micron to scrape the over-coating solution. After put in oven and maintain for 10 minutes, then the procedure of dry treatment will be performed. The step of performing the dry treatment to form the optical film comprises pre-dry step 104 and post-dry step 105, wherein the pre-dry step 104 further comprises a first pre-dry stage and a second pre-dry stage, the temperature of the first pre-dry stage is in a range of from 60° C. to 120° C. and maintain the drying time of 1 to 5 minutes. The temperature of the second pre-dry stage is in a range of from 80° C. to 140° C. and maintain the drying time of 5 to 30 minutes. Thereafter, performing the post-dry step 105, the temperature of the post-dry is in a range of from 60° C. to 160° C. and maintain the drying time of 30 to 60 minutes. Accordingly, an optical film having a thickness of 94 micron and 0.1% residue of the solvent is achieved. Hereinafter, proceeding a test of optical property and mechanical strength. The test of optical property comprises transmittance, Haze, b value etc. The test of mechanical strength comprises ductility, tensile strength, tensile modulus (MPa) etc. Moreover, discotic liquid crystals may be coated on the optical film to perform alignment process by employing roller friction or UV exposing, thereby forming a retardation optical film with a phase difference.

Furthermore, the optical film generated from the aforementioned method belongs to a dry film. Due to the optical film provided with excellent optical properties such as low nebulization, low yellowness index, high transmittance (more than 90 percent) between a wavelength of 400 nm and 700 nm within the range of visible light and high Abbe number, therefore the optical film substrate or optical protective film may be directly adopted. In other words, the functional optical film of the present invention may be applied to photoelectric panel display such as LCD, LED, OLED or PLED.

There are some advantages for the optical film of this invention produced by employing solvent molding technology to mix with PMMA, which includes (a) good heat-resistant, moderately mechanical property, low coefficient of optical elasticity, good optical properties such as low nebulization, low yellowness index, high Abbe number, high transmittance (more than 90 percent) between a wavelength of 400 nm and 700 nm within the range of visible light and provided with an optical film having an uniform surface (such as uniform thickness and good surface roughness); (b) to avoid forming an unstable material owing to melting, mixing or thermoplastic process; (c) moderate hydroscopicity property to solve effectively the variation of the optical film; (d) simplified process.

The above-mentioned optical film further comprising adding particles made of rubber elastic material into the material selected from the group consisting of PMMA, PMMA with a first functional group replaced by a second functional group and PMMA of intermixing a mixture to make the particles covered by the selected material, wherein the rubber elastic material comprises any one of butyl acrylate, PMMA, styrene and the copolymer thereof. The diameter of the fine particles may be less than 10 micron, preferably nano-meter scale. The adding amount of particles made of rubber elastic material are 2.5˜50 percentage by weight of selected PMMA, thereby improving the mechanical property of the optical film comprising ductility etc.

Silica may be added into the optical film during the manufacturing process, it is preferred that silica mix with the solvent prior to the mixing with PMMA. In addition, with respect to the procedure of adding silica, silica may be added together with PMMA during PMMA intermixing produce. Furthermore, silica may be added into PMMA after PMMA intermixing procedure. As to the adding amount of silica, it is preferred 0.5˜15 percentage by weight of the optical film.

Although specific embodiments have been illustrated and described, it will be obvious to those skilled in the art that various modifications may be made without departing from what is intended to be limited solely by the appended claims.

What is claimed is:

1. An optical film, comprising:
a material, at least selected from a group consisting of PMMA, PMMA with a first functional group replaced by a second functional group and PMMA of intermixing a mixture; and
a solvent, well mixed with the material selected from the group consisting of PMMA, PMMA with a first functional group replaced by a second functional group and PMMA of intermixing a mixture at a predetermine proportion to form a mixing solution under various conditions, thereby the optical film is formed from the mixing solution by way of a dry treatment.

2. The optical film of claim 1, wherein the material selected from the group consisting of PMMA, PMMA with a first functional group replaced by a second functional group and PMMA of intermixing a mixture is mixed with said solvent at 20˜40 percentage by weight.

3. The optical film of claim 1, wherein said first functional group is methyl, and said second functional group is selected from the group consisting of ethyl, propyl, isopropyl, butyl, isobutyl, tert-butyl, hexyl, isohexyl and cyclohexyl.

4. The optical film of claim 1, wherein said solvent is selected from the group consisting of methylbenzene, acetone, methyl acetate, aromatic, cycloalkanes, ethers, esters and ketones; wherein said aromatic comprises methylbenzene or o-, m-, p-xylene; said cycloalkanes comprises cyclohexane; said ethers comprises diethyl ether or tetrahydrofuran (THF); said esters comprises methyl acetate or ethyl acetate; and said ketones comprises acetone, methylethylketone (MEK) or 1-methylpyrrolidone (NMP).

5. The optical film of claim 1, further comprising adding particles formed of rubber elastic material into said material selected from the group consisting of PMMA, PMMA with a first functional group replaced by a second functional group and PMMA of intermixing a mixture to make the particles covered by the selected material.

6. The optical film of claim 5, wherein said rubber elastic material is selected from the group consisting of butyl acrylate, PMMA, styrene and the combination thereof, wherein the rubber elastic material adds into the material selected from PMMA, PMMA with a first functional group replaced by a second functional group and PMMA of intermixing a mixture at 2.5˜50 percentage by weight.

7. The optical film of claim 1, further comprising silica having 0.5˜15 percentage by weight of said optical film is added into said mixing solution by any percentage.

8. A method for making an optical film, comprising:
selecting at least one material from PMMA, PMMA with a first functional group replaced by a second functional group and PMMA of intermixing a mixture;
mixing said selected material with a solvent to form a mixing solution;
dispersing said mixing solution onto a substrate; and
performing a dry treatment to form said optical film.

9. The method of claim 8, wherein said selected material consisted any one of PMMA, PMMA with a first functional group replaced by a second functional group and PMMA of intermixing a mixture is mixed with said solvent at 20˜40 percentage by weight.

10. The method of claim 9, wherein residue of said solvent is less than 1 percentage by weight.

11. The method of claim 9, wherein said solvent is selected from the group consisting of methylbenzene, acetone, methyl acetate, aromatic, cycloalkanes, ethers, esters and ketones.

12. The method of claim 11, wherein said aromatic comprises methylbenzene or o-, m-, p-xylene, said cycloalkanes comprises hexamethylene, said ethers comprises diethyl ether or tetrahydrofuran (THF), said esters comprises methyl acetate or ethyl acetate, and said ketones comprises acetone, methylethylketone (MEK) or 1-methylpyrrolidone (NMP).

13. The method of claim 8, wherein said first functional group is methyl, and said second functional group is selected from the group consisting of ethyl, propyl, isopropyl, butyl, isobutyl, tert-butyl, hexyl, isohexyl and cyclohexyl.

14. The method of claim 8, wherein said mixing solution is formed by employing a solvent mixing technology.

15. The method of claim 8, wherein said mixing solution is dispersed onto said substrate by employing a solvent molding technology;
wherein said solvent molding technology is employed by any one of blade coating, winding stick coating, clockwise-or-counterclockwise roller coating, air curtain coating, wheeled coating, engraving tube coating, immersing coating, spin coating, slitting coating, squeezing coating, screening coating, extruded molding coating and injection molding coating;
wherein said substrate is selected from any one of glass substrate, plastic substrate, steel plate, steel belt and synthetic polymer with good surface uniformity; and
wherein said synthetic polymer is formed of a material selected from the group consisting of polyethyleneterephthalate (PET), polyethylenenaphthalate (PEN), polyethersulfone (PES), polyimide (PI), polyarylate (PAR), polycarbonate (PC) and natural fiber, and said natural fiber is formed of a material selected from the group consisting of cellulose acid (CA), cellulose diacetate (DAC) and cellulose triacetate (TAC).

16. The method of claim 8, wherein the thickness of said mixing solution dispersing onto said substrate is 150˜1200 micron.

17. The method of claim 8, further comprising coating discotic liquid crystals on said optical film to perform alignment process by employing roller friction or UV exposing, thereby forming a retardation optical film with a phase difference.

18. The method of claim 8, wherein said dry treatment is employed by using UV light irradiating said mixing solution dispersed onto said substrate, and the residue of said solvent is controlled by temperature and irradiating time of said dry treatment.

19. The method of claim 8, further comprising adding particles formed of rubber elastic material into said selected material selected from the group consisting of PMMA, PMMA with a first functional group replaced by a second functional group and PMMA of intermixing a mixture, wherein said rubber elastic material is selected from the group consisting of butyl acrylate, PMMA, styrene and the combination thereof, wherein the rubber elastic material adds into the material selected from PMMA, PMMA with a first functional group replaced by a second functional group and PMMA of intermixing a mixture at 2.5˜50 percentage by weight to make the rubber elastic material covered by the selected material.

20. The method of claim 8, further comprising adding silica having 0.5˜15 percentage by weight of said optical film into said mixing solution by any percentage.

21. The method of claim 8, wherein the step of performing the dry treatment to form the optical film comprises steps of pre-dry and post-dry, the temperature of the pre-dry is in a range of from 60° C. to 140° C. and the temperature of the post-dry is in a range of from 60° C. to 160° C.

22. The method of claim 21, wherein the step of the pre-dry further comprises a first pre-dry stage and a second pre-dry stage, the temperature of the first pre-dry stage is in a range of from 60° C. to 120° C. and the temperature of the second pre-dry stage is in a range of from 80° C. to 140° C.
